(19) United States
(12) Patent Application Publication
(10) Pub. No.: US 2021/0325983 A1
(43) Pub. Date: Oct. 21, 2021

(54) INFORMATION PROVIDING SYSTEM AND INFORMATION PROVIDING METHOD

(71) Applicant: Shimizu Corporation, Tokyo (JP)

(72) Inventor: Yuya IGARASHI, Tokyo (JP)

(73) Assignee: Shimizu Corporation, Tokyo (JP)

(21) Appl. No.: 17/270,469

(22) PCT Filed: Jun. 14, 2019
(86) PCT No.: PCT/JP2019/023771

§ 371 Date: Feb. 23, 2021

(30) Foreign Application Priority Data
Aug. 28, 2018 (JP) 2018-159602

(51) Int. Cl. G06F 3/041; G06T 7/521

(52) U.S. Cl. CPC G06F 3/041; G06T 2207/10028; G06T 7/521

(57) ABSTRACT

An information providing system including: a display provided in a predetermined information provision target area, the display being configured to: display information, including a touch-operation receivable range, to a user in the predetermined information provision target area; and-receive a predetermined input from the user through the touch-operation receivable range; a three-dimensional sensor configured to acquire three-dimensional shape data on surroundings, including the user, of the display; a processor configured to: determine an attribute of the user based on the acquired three-dimensional shape data; obtain a positional relation between the user and the display based on the acquired three-dimensional shape data; and control the display to display: the touch-operation receivable range at a position corresponding to the positional relation and the attribute of the user; and information content corresponding to the positional relation and the attribute of the user.

### FIELD

The present invention relates to an information providing system and an information providing method implemented by, for example, a digital signage or a touch panel disposed in a location such as a shopping area to provide, for example, map information and advertisement.

### BACKGROUND

Systems for determining an attribute of a user have been known such as a walking support system (see, for example, Patent Literature 1) configured to determine a person in need of walking assistance from a video of a surveillance camera, and a wheelchair-user detection system (see, for example, Patent Literature 2) using three-dimensional distance information acquired by a stereo camera.

Information providing devices such as signages for providing content in accordance with an attribute of a user are known. Examples of such information providing devices include a signage (see, for example, Patent Literature 3) configured to estimate an attribute of a person from an image captured by a camera and display individually optimized information or response to the person, and an operating board for elevators (see, for example, Patent Literature 4) configured to detect the height of a passenger to change the position of buttons displayed. Other examples include a touch panel display configured to detect the position of the head of a user touching the display and switch content to be provided to the user between information for adults and information for children, and a touch panel display configured to determine a wheelchair user and a person with weak sight based on the position of the head of the user and the distance (or a change in the distance) between the user and the display and provide information corresponding to individual users (see, for example, Patent Literature 5).

### CITATION LIST

### Patent Literature

Patent Literature 1: Japanese Patent No. 3697632

Patent Literature 2: Japanese Patent No. 4811651

Patent Literature 3: Japanese Patent No. 4951656

Patent Literature 4: WO2001/096224

Patent Literature 5: Japanese Patent No. 4831026

### SUMMARY

### Technical Problem

When a digital signage system includes a large monitor, the monitor may display buttons to be operated by users at a position too high to reach by wheelchair users or children. This problem may seem to be solved by combining the conventional techniques, but the following problems arise for the respective techniques.

The systems disclosed in Patent Literatures 1 and 3 using videos captured by a camera have privacy problems. The system disclosed in Patent Literature 2 using distance information acquired by a stereo camera has difficulty in distinguishing baby-carriage users from wheelchair users. The system disclosed in Patent Literature 4 including a sensor for measuring the height of a user cannot distinguish wheelchair users from children. The system disclosed in Patent Literature 5 configured to determine a wheelchair user based on the head position of the user and the distance between the user and the display may mistake a child away from the display for a wheelchair user.

The present invention has been made in view of the foregoing, and it is an object of the present invention to provide an information providing system and an information providing method with improved usability.

### Solution to Problem

To solve the problem and achieve the object, an information providing system according to the present invention includes: a display device provided in a predetermined information provision target area, the display device having: a display function configured to display information, including an operating unit, to a user in the information provision target area; and an operating function configured to receive a predetermined input from the user through the operating unit; a three-dimensional sensor configured to acquire three-dimensional shape data on surroundings, including the user, of the display device; an user attribute determination means configured to determine an attribute of the user based on the acquired three-dimensional shape data; a positional relation acquisition means configured to obtain a positional relation between the user and the display device based on the acquired three-dimensional shape data; and a controlling means configured to control the display device to display: the operating unit at a position corresponding to the positional relation and the attribute of the user; and information content corresponding to the positional relation and the attribute of the user.

Moreover, a method of providing information according to the present invention includes: a three-dimensional shape data acquisition step of acquiring three-dimensional shape data on surroundings of a display device provided in a predetermined information provision target area, the surroundings including a user in the information provision target area, the display device having: a display function configured to display information including an operating unit to the user; and an operating function configured to receive a predetermined input from the user through the operating unit; a user attribute determination step of determining an attribute of the user based on the acquired three-dimensional shape data; a positional relation acquisition step of obtaining a positional relation between the user and the display device based on the acquired three-dimensional shape data; and a control step of controlling the display device to display: the operating unit at a position corresponding to the positional relation and the attribute of the user; and information content corresponding to the positional relation and the attribute of the user.

### Advantageous Effects of Invention

The information providing system according to the present invention includes: a display device disposed in a predetermined information provision target area, the display device having a display function configured to display information including an operating unit to a user in the information provision target area and an operating function configured to receive a predetermined input from the user through the operating unit; a three-dimensional sensor configured to acquire three-dimensional shape data on surroundings, including the user, of the display device; a user attribute determination means configured to determine an attribute of the user based on the acquired three-dimensional shape data; a positional relation acquisition means configured to obtain a positional relation between the user and the display device based on the acquired three-dimensional shape data; and a controlling means configured to control the display device to display the operating unit at a position corresponding to the positional relation and the attribute of the user and display information content corresponding to the positional relation and the attribute of the user. This configuration can improve usability of the information providing system.

The information providing method according to the present invention includes: a three-dimensional shape data acquisition step of acquiring three-dimensional shape data on surroundings of a display device disposed in a predetermined information provision target area, the surroundings including a user in the information provision target area, the display device having a display function configured to display information including an operating unit to the user and an operating function configured to receive a predetermined input from the user through the operating unit; a user attribute determination step of determining an attribute of the user based on the acquired three-dimensional shape data; a positional relation acquisition step of obtaining a positional relation between the user and the display device based on the acquired three-dimensional shape data; and a control step of controlling the display device to display the operating unit at a position corresponding to the positional relation and the attribute of the user and display information content corresponding to the positional relation and the attribute of the user. This configuration can improve usability of the information providing method.

### BRIEF DESCRIPTION OF DRAWINGS

FIG. 1 is a diagram illustrating a general configuration of an information providing system according to an embodiment of the present invention.

FIG. 2 is a flowchart illustrating a general procedure of an information providing method according to the embodiment of the present invention.

FIG. 3 is a diagram illustrating an example procedure of acquiring three-dimensional shape data.

FIG. 4 is a diagram illustrating an example procedure of determining an attribute.

FIG. 5 is a diagram illustrating a first example according to the present invention.

FIG. 6 is a diagram illustrating a second example according to the present invention.

### DESCRIPTION OF EMBODIMENT

The following describes an embodiment of the information providing system and the information providing method according to the present invention with reference to the accompanying drawings. The embodiment is not intended to limit the scope of the present invention.

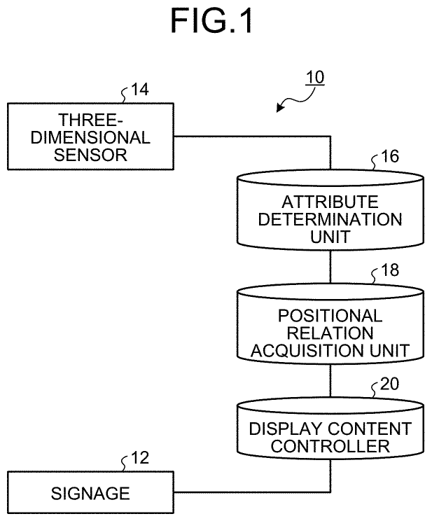

As illustrated in FIG. 1, an information providing system 10 according to the present embodiment includes a signage 12, a three-dimensional sensor 14, an attribute determination unit 16, a positional relation acquisition unit 18, and a display content controller 20. The attribute determination unit 16, the positional relation acquisition unit 18, and the display content controller 20 are implemented by an arithmetic processing function of a computer, which is not illustrated.

The signage 12 is disposed, for example, on the floor of a shopping area (information provision target area). The signage 12 includes a large touch-panel display (display device) configured to provide information such as map information, ticket information, and advertisement. The signage 12 has a display function configured to display information content including operating buttons (operating unit) to a user near the installation location, and an operating function configured to receive a touch operation with, for example, a finger of the user on the operating buttons. The large display according to the present embodiment has a screen size of approximately 2 meters high and 1.5 meters wide, but the size of the display is not limited to this.

The three-dimensional sensor 14 acquires three-dimensional shape data on the surface of objects including users near the signage 12, and is disposed close to the signage 12 (close to, for example, the upper portion of the signage 12). For the three-dimensional sensor 14, various kinds of contactless sensors can be used such as a laser imaging detection and ranging (LiDAR) sensor that emits laser beams. To acquire three-dimensional shape data on objects in the surroundings, the three-dimensional sensor 14 can use any desired known method. When, for example, the three-dimensional sensor 14 is a laser-emitting sensor, the sensor emits linear laser beams to the surroundings and receives reflected beams from the surface of the objects irradiated with the laser beams. The sensor then acquires three-dimensional shape data on the surface of the objects in the surroundings based on the light-receiving signals and the position and direction data of the laser beams.

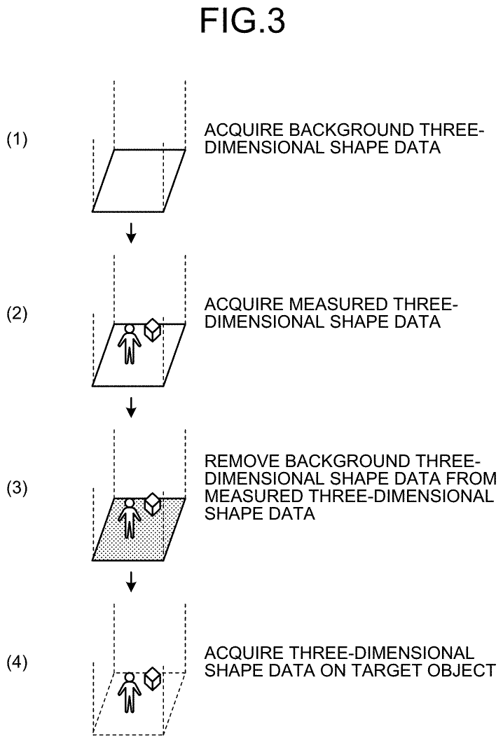

In the present embodiment, for example, a method illustrated in FIG. 3 can be used to acquire three-dimensional shape data on the surface of objects including users. First, as illustrated in FIG. 3(1), the three-dimensional sensor 14 acquires three-dimensional shape data (background three-dimensional shape data) with no user present in front of or in the surroundings of the signage 12. As illustrated in FIG. 3(2), the three-dimensional sensor 14 then acquires three-dimensional shape data (measured three-dimensional shape data) in the presence of a user. As illustrated in FIG. 3(3), the background three-dimensional shape data is removed from the measured three-dimensional shape data. With this process, the three-dimensional sensor 14 can acquire three-dimensional shape data on a target object such as a user as illustrated in FIG. 3(4).

The attribute determination unit 16 determines an attribute of a user based on the acquired three-dimensional shape data. The attribute determination unit 16 functions as a user attribute determination means according to the present invention. Examples of typical user attributes can include an adult, a child (for example, a pre-school child), a wheelchair user, and a baby-carriage user, but the user attributes according to the present invention are not limited to these examples.

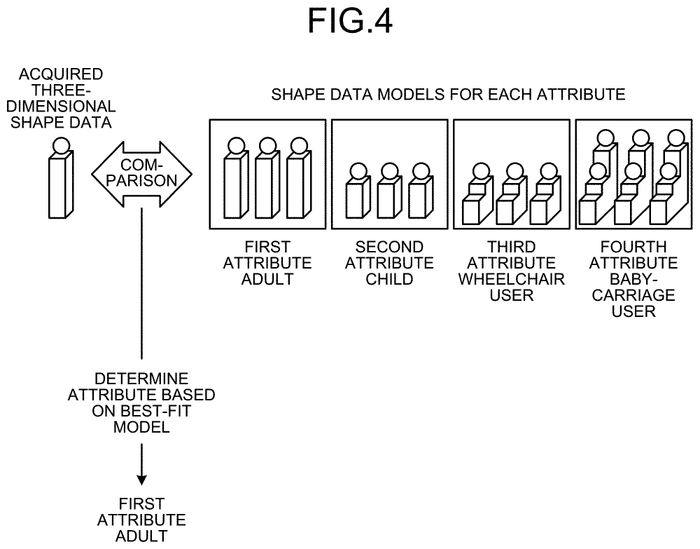

To determine an attribute of a user, the attribute determination unit 16 can use a method illustrated in, for example, FIG. 4. In this method, as illustrated in FIG. 4, the attribute determination unit 16 compares the three-dimensional shape data acquired by the three-dimensional sensor 14 with shape data models previously prepared for each attribute and then determines the attribute of the user based on a best-fit model.

In the example of FIG. 4, there are four types of user attributes, which are a first attribute (adult), a second attribute (child), a third attribute (wheelchair user), and a fourth attribute (baby-carriage user). Each attribute has three shape data models prepared in, for example, a database (not illustrated). In this example, the attribute determination unit 16 compares the acquired three-dimensional shape data with shape data models of each attribute, and determines that a shape data model for the first attribute (adult) best fits the three-dimensional shape data. The attribute determination unit 16 thus determines that the attribute of the user is the first attribute (adult) corresponding to this shape data model.

If the attribute determination unit 16 determines that a shape data model for the second attribute (child) best fits the three-dimensional shape data as a result of the comparison, the attribute determination unit 16 determines the second attribute (child) to be the attribute of the user. This configuration is also applicable to the cases of the third attribute (wheelchair user) and the fourth attribute (baby-carriage user). Although, in the example of FIG. 4, three shape data models are prepared for each attribute, the present invention is not limited to this. Four or more various types of shape models may be prepared.

The positional relation acquisition unit 18 acquires a relative position of the user with respect to the signage 12 based on the acquired three-dimensional shape data. The positional relation acquisition unit 18 functions as a positional relation acquisition means according to the present invention. To acquire positional relation, for example, the positional relation acquisition unit 18 can use a method of calculating the respective distance and direction of the user and the signage 12 to the three-dimensional sensor 14 from the three-dimensional shape data on the surroundings acquired by the three-dimensional sensor 14 and acquiring a relative position of the user with respect to the signage 12 from the calculation result.

The display content controller 20 controls the signage 12 to display the operating buttons at a position corresponding to the positional relation and the attribute of the user, and display information content corresponding to the positional relation and the attribute of the user. The display content controller 20 functions as a controlling means according to the present invention and includes a database, which is not illustrated. The database stores therein the information content including display position information (operating interface information) for the operating buttons in association with positional relations and attributes of users. The display content controller 20 reads information content corresponding to the positional relation and the attribute of the user and sets and displays the information content on the signage 12.

The display content controller 20 controls the display in the following exemplary manner. When, for example, the attribute of a user is a wheelchair user or a child, the display content controller 20 controls the signage 12 to display the operating unit such as the operating buttons in a lower area on the display screen. When the attribute of a user is a child, phonetic characters are written along with characters on the display screen.

When the information content provided by the signage 12 is map information and when the attribute of a user is a wheelchair user, the signage 12 displays facilities such as multipurpose restrooms, which may be needed more often by wheelchair users, in an enhanced mode. When the attribute of a user is a baby-carriage user, the signage 12 displays facilities such as nursing rooms, which may be needed more often by baby-carriage users, in an enhanced mode.

When the signage 12 has a function of a ticket machine (when the information content is ticket information), the signage 12 displays information content that allows the child to easily select the child rate. In this case, for example, the signage 12 displays the operating unit such as the operating buttons in a lower area on the display screen and displays the child rate in an enhanced mode.

A touch-operation receivable range for the operating buttons displayed on the display screen may be arranged in accordance with the position of the user. For example, disposing the touch-operation receivable range on a side closer to the position of the user allows the user to operate the operating buttons more effortlessly, thereby improving system usability.

The following describes specific examples of the display control described above.

### FIRST EXAMPLE

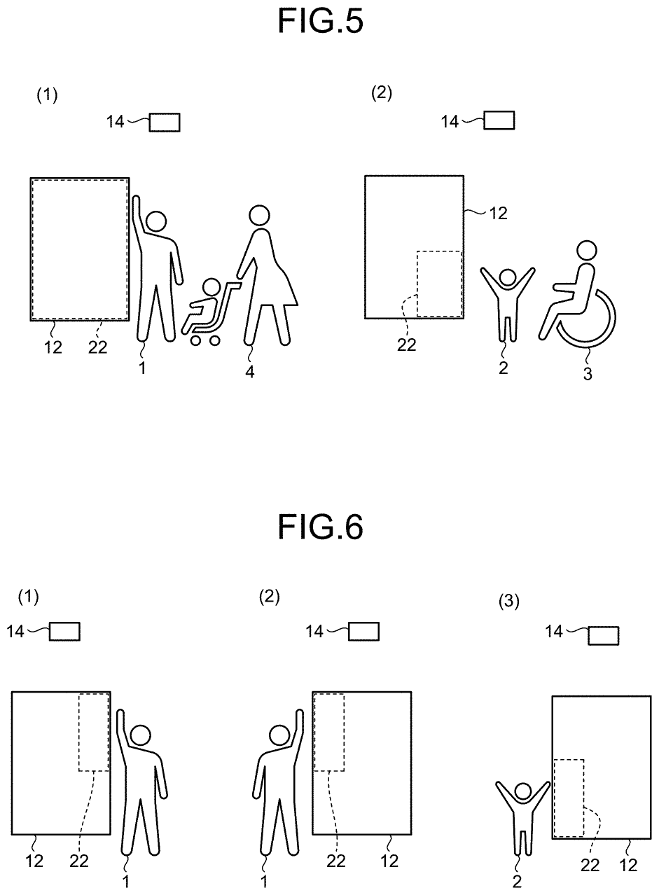

In a first example, the touch-operation receivable range for the operating buttons is changed in accordance with the attribute of the user. FIG. 5 is a diagram illustrating the first example. When attributes of users are determined to be an adult 1 and a baby-carriage user 4 as illustrated in FIG. 5(1), a touch-operation receivable range 22 for the operating buttons is set to a standard display area.

When attributes of users are determined to be a child 2 and a wheelchair user 3 as illustrated in FIG. 5(2), the touch-operation receivable range 22 for the operating buttons is set at a lower area on the display screen of the signage 12 (for example, at a lower portion of the screen) and the operating buttons are displayed in this area. Alternatively, the entire touch-operation receivable range of a standard size may be reduced and set as the touch-operation receivable range 22. The touch-operation receivable range 22 for the operating buttons may be set in accordance with the position of a user. When, for example, the position of a user is determined to be at the right side of the signage 12 in the front view as illustrated in FIG. 5(2), the touch-operation receivable range 22 may be set at the lower right of the screen. The information content may be displayed only in the touch-operation receivable range 22, or may be displayed beyond this range.

### SECOND EXAMPLE

In a second example, the touch-operation receivable range for the operating buttons is changed in accordance with the positional relation between the user and the signage 12. FIG. 6 is a diagram illustrating the second example. When the attribute of a user is determined to be the adult 1 and the position of the user is determined to be at the right side of the signage 12 in the front view as illustrated in FIG. 6(1), the touch-operation receivable range 22 for the operating buttons may be set at the upper right of the screen. When the attribute of a user is determined to be the adult 1 and the position of the user is determined to be at the left side of the signage 12 in the front view as illustrated in FIG. 6(2), the touch-operation receivable range 22 for the operating buttons may be set at the upper left of the screen.

When the attribute of a user is determined to be the child 2 and the position of the user is determined to be, for example, at the left side of the signage 12 in the front view as illustrated in FIG. 6(3), the touch-operation receivable range 22 for the operating buttons may be set at the lower left of the screen. The information content may be displayed only in the touch-operation receivable range 22, or may be displayed beyond this range.

The following describes operations and functions of the information providing system 10 having the configuration described above.

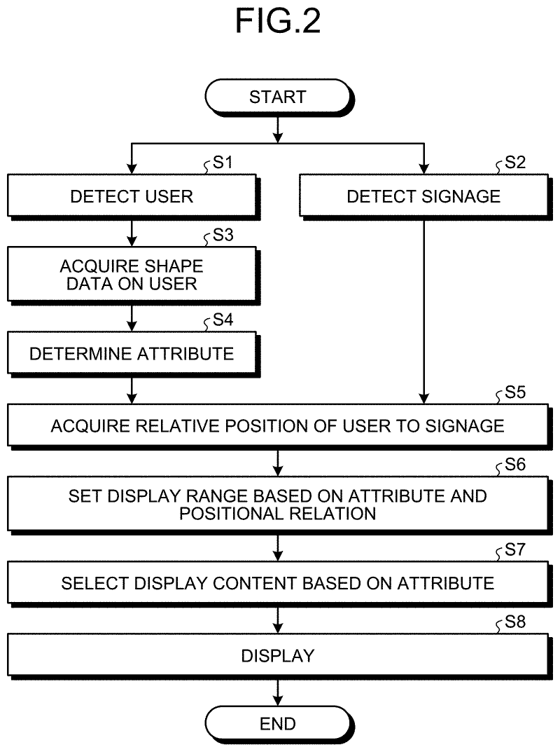

As illustrated in FIG. 2, first, the three-dimensional sensor 14 acquires three-dimensional shape data on the surroundings to detect a user (Step S1) and the signage 12 (Step S2) from the acquired three-dimensional shape data.

Subsequently, three-dimensional shape data on the user is acquired by using, for example, the method illustrated in FIG. 3 (Step S3). The attribute determination unit 16 determines the attribute of the user from the acquired three-dimensional shape data (Step S4). To determine the attribute, for example, the method illustrated in FIG. 4 can be used. Based on the results of Step S4 and Step S2, the positional relation acquisition unit 18 acquires a relative position of the user with respect to the signage 12 (Step S5).

Based on the acquired attribute of the user and positional relation, the display content controller 20 sets the touch-operation receivable range for the operating buttons and the display range for the information content on the display screen of the signage 12 (Step S6). The display content controller 20 selects information content to be displayed based on the attribute of the user (Step S7). The display content controller 20 displays, for example, the operating buttons in the range set at Step S6 and displays the information content selected at Step S7 (Step S8). Step S6 to Step S8 are control processing performed by the display content controller 20.

The information providing system according to the present embodiment includes the three-dimensional sensor 14 to determine an attribute of a user and acquires positional relation between the user and the signage 12 based on, for example, the shape data on the user and the signage 12. This configuration allows the information providing system to display information suitable for the attribute of the user and the positional relation. In particular, this configuration can implement an operating interface corresponding to the positional relation between the user and the signage 12. In this regard, the information providing system according to the present embodiment can improve usability.

The information providing system according to the present embodiment does not deal with more information on privacy than necessary. The information providing system can easily distinguish a wheelchair user from a baby-carriage user, which is difficult for conventional techniques, by using the three-dimensional sensor 14.

In the embodiment above, the signage 12 is described as an example of the display device, but the display device according to the present embodiment is not limited to this. The display device may be a touch panel, or a touch-panel display device embedded in, for example, ticket machines. The display device of any of the examples can have the same effects as those of the embodiment above.

As described above, the information providing system according to the present invention includes: a display device disposed in a predetermined information provision target area, the display device having a display function configured to display information including an operating unit to a user in the information provision target area and an operating function configured to receive a predetermined input from the user through the operating unit; a three-dimensional sensor configured to acquire three-dimensional shape data on surroundings, including the user, of the display device; a user attribute determination means configured to determine an attribute of the user based on the acquired three-dimensional shape data; a positional relation acquisition means configured to obtain a positional relation between the user and the display device based on the acquired three-dimensional shape data; and a controlling means configured to control the display device to display the operating unit at a position corresponding to the positional relation and the attribute of the user and display information content corresponding to the positional relation and the attribute of the user. This configuration can improve usability of the information providing system.

The information providing method according to the present invention includes: a three-dimensional shape data acquisition step of acquiring three-dimensional shape data on surroundings of a display device disposed in a predetermined information provision target area, the surroundings including a user in the information provision target area, the display device having a display function configured to display information including an operating unit to the user and an operating function configured to receive a predetermined input from the user through the operating unit; a user attribute determination step of determining an attribute of the user based on the acquired three-dimensional shape data; a positional relation acquisition step of obtaining a positional relation between the user and the display device based on the acquired three-dimensional shape data; and a control step of controlling the display device to display the operating unit at a position corresponding to the positional relation and the attribute of the user and display information content corresponding to the positional relation and the attribute of the user. This configuration can improve usability of the information providing method.

### INDUSTRIAL APPLICABILITY

The information providing system and the information providing method according to the present invention are advantageous for use in devices such as digital signages or touch panels disposed in, for example, a shopping area to provide information such as map information and advertisement, and in particular, the system and method are suitable for improving usability.

### REFERENCE SIGNS LIST

10 Information providing system

12 Signage (display device)

14 Three-dimensional sensor

16 Attribute determination unit (user attribute determination means)

18 Positional relation acquisition unit (positional relation acquisition means)

20 Display content controller (controlling means)

22 Touch-operation receivable range

1. An information providing system comprising:
a display provided in a predetermined information provision target area, the display being configured to:
display information, including a touch-operation receivable range, to a user in the predetermined information provision target area; and
receive a predetermined input from the user through the touch-operation receivable range;
a three-dimensional sensor configured to acquire three-dimensional shape data on surroundings, including the user, of the display; and
a processor including hardware, the processor being configured to:
determine an attribute of the user based on the acquired three-dimensional shape data;
obtain a positional relation between the user and the display based on the acquired three-dimensional shape data; and
control the display to display:
the touch-operation receivable range at a position corresponding to the positional relation and the attribute of the user; and
information content corresponding to the positional relation and the attribute of the user.

2. A method of providing information, comprising:
acquiring a three-dimensional shape data on surroundings of a display provided in a predetermined information provision target area, the surroundings including a user in the predetermined information provision target area, the display being configured to:
display information including a touch-operation receivable range to the user; and
receive a predetermined input from the user through the touch-operation receivable range;
determining an attribute of the user based on the acquired three-dimensional shape data;
obtaining a positional relation between the user and the display based on the acquired three-dimensional shape data; and
controlling the display to display:
the touch-operation receivable range at a position corresponding to the positional relation and the attribute of the user; and
information content corresponding to the positional relation and the attribute of the user.
